(19) United States
(12) Patent Application Publication
(10) Pub. No.: US 2026/0245096 A1
(43) Pub. Date: Aug. 20, 2026

(54) SHARING COMPLIANCE DATA IN AN ELECTRONIC FINANCIAL TRANSACTION WITH SECURITY AND AUDITABILITY

(71) Applicant: Klearium Inc., San Francisco, CA (US)

(72) Inventors: Michael Alan Gama-Lobo, Seattle, WA (US); David Gilbert Kleiman, San Rafael, CA (US); Luis Maximiliano Koberg, London (GB); Marek Suliga, London (GB)

(73) Assignee: Klearium Inc., San Francisco, CA (US)

(21) Appl. No.: 19/541,319

(22) Filed: Feb. 16, 2026

Related U.S. Application Data
(60) Provisional application No. 63/759,304, filed on Feb. 17, 2025.

(51) Int. Cl. G06Q 20/40; G06Q 20/02; G06Q 20/16; G06Q 20/38

(52) U.S. Cl. CPC G06Q 20/4016; G06Q 20/023; G06Q 20/16; G06Q 20/3827; G06Q 20/389

(57) ABSTRACT

A system and method for sharing compliance data in electronic financial transactions involves receiving a sender's request to process a transaction for an originator to a recipient for a beneficiary. A record is created with the originator's and beneficiary's information, along with a timestamp for vetting by the sender, recipient, or both. This record is stored in an immutable database and assigned a unique identifier, which is included in a telecommunications message sent by the sender. The recipient's authorization to access the database is verified. If valid, the unique identifier is used to match a signature linked to the record in the database, validating the transaction. Upon validation, the recipient gains access to the record using the unique identifier. If the recipient is unauthorized or the transaction cannot be validated, access is denied. This method ensures secure validation and controlled access to compliance data during financial transactions.

### CROSS-REFERENCE TO RELATED APPLICATIONS

This application claims priority from and is related to U.S. Provisional Application No. 63/759,304, entitled “SHARING COMPLIANCE DATA IN AN ELECTRONIC FINANCIAL TRANSACTION WITH SECURITY AND AUDITABILITY” with attorney docket number 8111-V25-003, filed Feb. 17, 2025, which is hereby incorporated into the present application by reference in its entirety.

### TECHNICAL FIELD

The present disclosure generally relates to financial transactions between sender and a beneficiary, and more particularly for sharing compliance data in an electronic financial transaction.

### BACKGROUND

Financial institutions are required to perform Know Your Customer (KYC) and Know Your Business (KYB) checks to verify the identities, business details, and probity of their clients, and to ensure compliance with any transaction nuances. The standard practice of collecting client data does not address issues that may arise from transactions occurring after the account is opened. These are widely part of the Know Your Transaction (KYT) data. Additionally, neither the originator nor the beneficiary has access to the data collected by the other party, and intermediary financial institutions have no access to any of this data. Sharing consolidated transactional data securely with “in-flow’ stakeholders such as financial institutions is crucial for various regulatory and business purposes. Traditional methods of data sharing pose significant risks, including data breaches and unauthorized access, not to mention business inefficiencies due to unconsolidated or missing KYT data.

### SUMMARY OF THE INVENTION

The invention relates to a method of embedding KYT information securely via financial services systems and sharing such information with in-flow stakeholders. Specifically, it involves creating snapshots of KYT data and all vetting processes this data is subject to, securing these snapshots, and sharing them through an embeddable reference in a telecommunications message such as Worldwide Interbank Financial Telecommunications (SWIFT) message, a Brazil, Russia, India, China (BRIC) Pay message, local or regional RTGS messages such as ACH (US) CHAPS (UK) or Fast Payment System messaging such as (RTP, FedNow (US) FPS (UK) or any other payment messaging system that supports embedded information, served from an immutable storage solution and method for securely accessing such data in an immutable database. For this invention's purposes, KYT data is defined as a unique set of transaction-related data, which includes more commonly collected KYC and KYB data. This definition ensures clarity when referring to KYT data, but if we refer to KYC or KYB specifically, these are subsets of the broader KYT dataset. The system integrates multiple data sources, periodically captures KYT data along with various transaction information generated through an in-depth, multi-layer vetting process, and securely stores the snapshots in an immutable database. The snapshots are timestamped and cryptographically signed, ensuring data integrity and authenticity. Hash references are generated for each snapshot to facilitate secure access and verification by authorized individuals.

More specifically disclosed is a system and method for sharing compliance data in electronic financial transactions, implemented on a server and involving a series of steps. The process begins when the server receives a request from a sender to initiate a financial transaction from an originator to a recipient on behalf of a beneficiary. A record is then created, containing information about the originator, the beneficiary, and a timestamp, which is used to vet the record by the sender, the recipient, or both parties. This record is stored in an immutable database and assigned a unique identifier for reference.

The unique identifier is embedded in a telecommunications message sent from the sender to the recipient. The server verifies whether the recipient is a valid user authorized to access the immutable database. If the recipient is validated, the identifier is used to match a signature associated with the stored record in the database with a signature generated by the recipient. If the financial transaction is successfully validated, the recipient is granted access to the record in the database using the unique identifier. If the recipient is not a valid user or the transaction cannot be validated, access is denied.

The method also incorporates additional enhancements to ensure compliance and secure transaction processing. Validation may involve comparing the hashes associated with the record in the database and the recipient-generated hash. Telecommunications messages used in the process can include formats such as SWIFT, BRIC Pay, or other payment messaging systems that support embedded information, such as RTGS (Real Time Gross Settlement). For SWIFT messages, unique identifiers can be placed in MT or MX fields, and the sender and recipient may use respective SWIFT codes.

Furthermore, the method supports the inclusion of Know Your Business (KYB) and Know Your Customer (KYC) documentation, such as business licenses, registrations, or ultimate beneficial owner details. For outbound payments of tangible goods, the record may include invoice details, amounts, product descriptions, and bank information. Data used in the record can originate from systems such as CRM (customer relationship management), ERP (enterprise resource planning), AML (Anti-Money Laundering) tools, transaction monitoring, rules-based systems, or other vetting services, and is standardized, categorized, and sorted before record creation.

### BRIEF DESCRIPTION OF THE DRAWINGS

The accompanying figures, where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 depicts an overall flow of the integrated data vetting and embedding, according to one example of the present invention;

FIG. 2 depicts an overall system architecture, according to one example of the present invention;

FIG. 3 depicts an overall flow of the data collection and snapshot creation process, according to one example of the present invention;

FIG. 4 depicts an overall flow of sharing, embedding and accessing process, according to one example of the present invention;

FIG. 5 depicts an overall flow of the sharing of compliance data, according to one example of the present invention;

FIG. 6 through FIG. 8 is an example of compliance data vetting report, according to one aspect of the present invention; and

FIG. 9 depicts a block diagram illustrating a processor to implement the process and system described above, according to an example.

### DETAILED DESCRIPTION OF THE DISCLOSURE

As required, embodiments are disclosed herein; however, it is to be understood that the disclosed embodiments are merely examples and that the methods described below can be embodied in various forms. Therefore, specific structure and functional details disclosed herein are not to be interpreted as limiting, but merely as a representative basis for teaching one skilled in the art to variously employ the present subject matter in virtually any appropriately detailed structure and function. Further, the terms and phrases used herein are not intended to be limiting, but rather, to provide an understandable description of the concepts.

### Non-Limiting Definitions

The terms “a”, “an”, and “the” are intended to include the plural forms as well unless the context clearly indicates otherwise.

The term “about” or “approximately” applies to all numeric values, whether or not explicitly indicated. These terms generally refer to a range of numbers that one of skill in the art would consider equivalent to the recited values (i.e., having the same function or result). In many instances, these terms may include numbers that are rounded to the nearest significant figure.

The term “adapted to” describes the hardware, software, or a combination of hardware and software that is capable of, able to accommodate, to make, or that is suitable to carry out a given function.

The term “another”, as used herein, is defined as at least a second or more.

The phrase “associated with,” as well as derivatives thereof, can mean to include, be included within, interconnect with, contain, be contained within, connect to or with, couple to or with, be communicable with, cooperate with, interleave, juxtapose, be proximate to, be bound to or with, have, have a property of, have a relationship to or with, or the like.

The phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The term “communicate,” as well as derivatives thereof, encompasses both direct and indirect communication.

The terms “comprises” and/or “comprising”, when used in this specification, specify the presence of stated features, steps, operations, elements, and/or components but do not preclude the presence or addition of one or more other features, integers, steps, operations, elements, components, and/or groups thereof.

The term “configured to”, describes the hardware, software, or a combination of hardware and software that is adapted to, set up, arranged, built, composed, constructed, designed, or that has any combination of these characteristics to carry out a given function.

The term “coupled”, is defined as “connected,” although not necessarily directly and not necessarily mechanically.

The term “embedding” is the act of placing the snapshot in the text or information field of a SWIFT message. The reference includes a URL or identifier that directs the recipient to the secure snapshot. The reference to the snapshot adheres to these character constraints to ensure compatibility and seamless integration with SWIFT messaging systems. The remittance information field must comply with the character set requirements specified in SWIFT MT and MX ISO 20022 messages.

The terms “including” and “having,” as used herein, are defined as comprising (i.e., open language).

The term “Know Your Business” (KYB) is a process that banks and financial institutions use to verify the identity and legitimacy of businesses they engage with, making it a critical component of anti-money laundering (AML) practices. KYB plays a vital role in preventing financial crimes such as money laundering and fraud, helping banks maintain their reputation and avoid regulatory enforcement actions. The KYB process involves several key steps, including verifying a business's ownership and control structure, confirming its existence and funding sources, assessing associated risks and expected transaction sizes, and identifying its Ultimate Beneficial Owners (UBOs). This thorough examination ensures that businesses operate transparently and within legal boundaries. To complete KYB verification, institutions typically require specific documents and information, such as business registration papers, articles of incorporation, details of owners and major shareholders, business identification, AML checks, including sanctions, adverse media, ownership structure, risk assessment, regulatory compliance, financial information, operational information, global trade activities, and financial statements. While KYB focuses on verifying businesses, it is closely related to Know Your Customer (KYC), which targets the identities of individual clients. Both KYB and KYC are not one-time actions but ongoing processes that require businesses and financial institutions to continuously monitor and assess customer transaction activities to mitigate risks effectively.

The term “Know Your Customer” (KYC) is a process aimed at verifying the identity and background of customers or clients to ensure compliance with regulatory requirements. It focuses on validating personal and financial information, such as identity, address, and financial history, of individuals or legal entities. Personal Identification, including personal documents, contact information, financial information, and their validation against sanctions lists, adverse media searches, PEP (Politically Exposed Person) status, and risk assessment. KYC is widely used by banks, insurance companies, and other organizations that offer financial services. This process typically occurs during the onboarding of new customers and is periodically updated to maintain accuracy. The data collected includes personal details, identification documents, and financial records. KYC is essential for complying with Anti-Money Laundering (AML) and Counter-Terrorism Financing (CTF) regulations, as well as jurisdiction-specific financial regulations. Its primary goal is to prevent fraud, identity theft, and illegal activities by ensuring that customers are legitimate and trustworthy. KYC requires significant customer interaction during the onboarding process and for periodic reviews. However, challenges include maintaining the accuracy of customer information, combating fraudulent attempts, and safeguarding sensitive customer data. Despite these challenges, KYC remains a cornerstone of risk mitigation in the financial industry.

The term “Know Your Transaction” (KYT) refers to a process for verifying the legitimacy and compliance of individual financial transactions. It focuses on analyzing the source and destination of funds to ensure adherence to legal and regulatory standards. KYT is primarily used by financial institutions, cryptocurrency exchanges, and payment processors, where it is applied in real-time or near real-time to monitor, detect, and flag suspicious activities. The data collected includes transaction-specific details such as the sender and receiver, transaction amount, date, time, transaction details, geographical footprint, transaction risk assessment, invoice vetting, and product vetting information. KYT plays a critical role in supporting compliance with Anti-Money Laundering (AML) and Counter-Terrorism Financing (CTF) regulations by helping to identify and prevent illicit activities. Unlike some customer verification methods, KYT is minimally invasive, as it focuses primarily on monitoring transactional data without requiring significant customer interaction. However, it faces the challenge of efficiently analyzing large volumes of transactions in real-time to detect irregular patterns or activities.

The term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

The term “simultaneous” means computations are carried out at the same time, which, for larger data sets with various constraints, cannot possibly be completed by a group of humans and must be performed by a computer.

The term “snapshot creation” is a copy of the KYT data recorded a specific time. The snapshot is a read-only, timestamped copy of the data that captures its state at a specific point in time. The snapshot includes all relevant details necessary for transaction validation and verification.

The terms “substantial” and “substantially” mean, when comparing various parts to one another, that the parts being compared are equal to or are so close enough in dimension that one skilled in the art would consider the same. Substantial and substantially, as used herein, are not limited to a single dimension and specifically include a range of values for those parts being compared. The range of values, both above and below (e.g., “+/−” or greater/lesser or larger/smaller), includes a variance that one skilled in the art would know to be a reasonable tolerance for the parts mentioned.

The term “telecommunications message” is any pay message or payment messaging systems such as Worldwide Interbank Financial Telecommunications (SWIFT) message, a Brazil, Russia, India, China (BRIC) Pay message, local or regional RTGS messages such as ACH (US) CHAPS (UK) or Fast Payment System messaging such as (RTP, FedNow (US) FPS (UK) or any other payment messaging system that supports embedded information..

Note that not all of the activities described above in the general description or the examples are required, that a portion of a specific activity may not be required, and that one or more further activities can be performed in addition to those described. Still further, the order in which activities are listed is not necessarily the order in which they are performed.

### General Overview

The invention relates to a method of embedding Know Your Transaction (KYT) information securely via financial services systems and sharing such information with in-flow stakeholders. Specifically, it involves creating snapshots of KYT, KYB, KYC, and all vetting processes this data is subject to, securing these snapshots, and sharing them through an embeddable reference in a SWIFT message, served from an immutable storage solution and method for securely accessing such data in an immutable database. For this invention's purposes, KYT data is defined as a unique set of transaction-related data, which includes more commonly accepted KYC and KYB data. This definition ensures clarity: referring to KYT data, but if we refer to KYC or KYB specifically, these are subsets of the broader KYT dataset. The system integrates multiple data sources, performs periodic snapshots of KYT data along with various transaction information produced through an in-depth, multi-layer vetting process, and securely stores snapshots in an immutable database. The snapshots are timestamped and cryptographically signed, ensuring data integrity and authenticity.

The present invention provides a system and method for securely sharing and accessing KYT snapshots using an immutable database. The system collects data from multiple sources, creates periodic snapshots of the data, timestamps, and cryptographically signs each snapshot, and stores the snapshots in an immutable database. Authorized in-flow stakeholders can access the data securely using hash references, ensuring data integrity and compliance with regulatory requirements. The solution includes:
Snapshot Creation: Capturing and aggregating secure snapshots of the KYT data and associated vetting.
Security Measures: Protecting the snapshot with password protection and serving it from immutable storage.
Embedding capabilities. Embedding a reference to the secure snapshot through protocols specific to the nature of financial transactions, like SWIFT messages, adhering to the character set requirements specified in SWIFT MT and MX ISO 20022 messages.

### Data Vetting and Embedding Flow

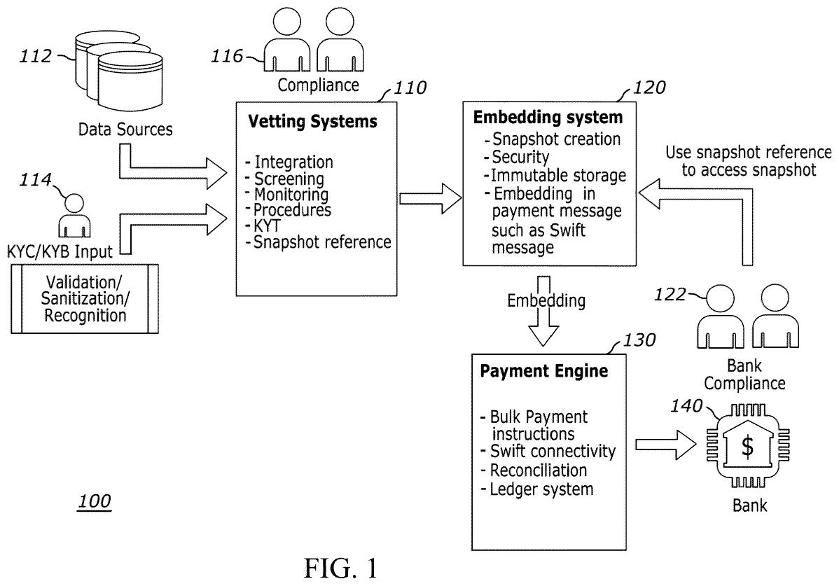

FIG. 1 depicts an overall flow 100 of the integrated data vetting and embedding. Data from databases 112 and individuals 114 are validated, sanitized, and recognized. The sanitizing includes the process of removing extraneous information from a document to ensure that only the intended information can be accessed from it. Further, the sanitizing may also involve converting data into a standardized format required by the data vetting and embedding flow system 100.

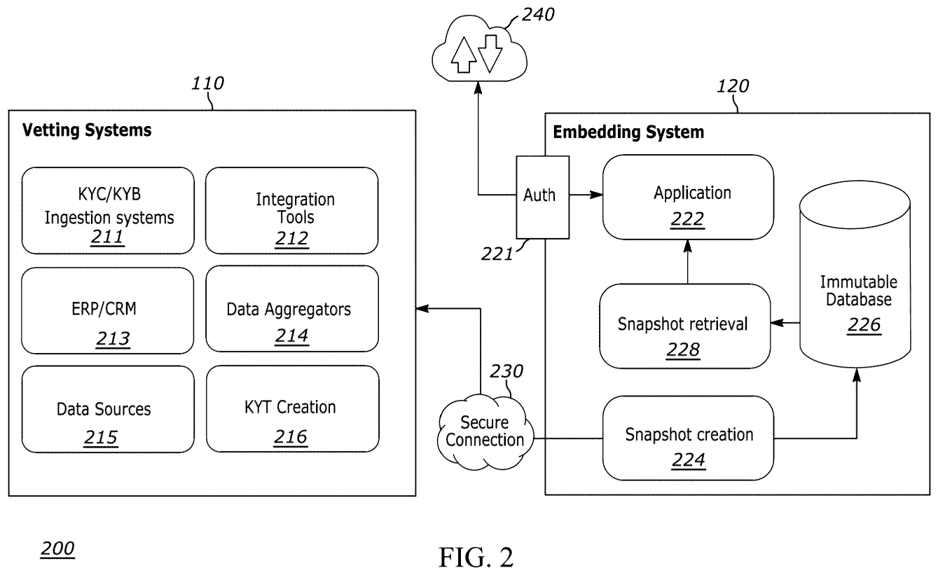

Data enters the vetting systems 110 for integration, screening, monitoring, and procedural handling, as will be further described with reference to FIG. 2 below. The vetting systems 110 send the data to the embedding system 120 as shown.

The embedding system 120 creates a secure and immutable snapshot reference. The snapshot is shared so that it may be accessed by the payment engine 130 and other users 122, such as beneficiary banks or intermediary banks.

The payment engine 130 processes bulk payment instructions and connects to a financial network, such as the SWIFT network, a BRIC (Brazil, Russia, India, China) pay message, or other payment messaging system, such as RTGS, which is a system that allows for the real-time transfer of money between banks, passing a snapshot reference, for banking compliance 140.

### Overall System Architecture

FIG. 2 depicts an overall system architecture 200. The vetting system 110, as described previously, creates snapshots based on files collected in collaboration with multiple systems 112, 114. More specifically, the vetting system 110 includes the following modules:
KYT Ingestion Systems 211 are specifically designed to ingest, validate, sanitize, and store KYT data. Examples of KYT Ingestion Systems 211 include custom-made database systems, AIO (3rd party system), and OCR systems (Mindee)
Integration Tools 212 are tools used to integrate data from multiple sources. Examples of Integration Tools 212 include Internet scrapers, software tools such as Compliance Hub (internal system)
ERP/CRM (Enterprise Resource Planning and Customer Relationship Management) systems 213 that store business-related data and customer information. Examples of ERP/CRM systems 213include those from SAP, Oracle, Salesforce, Microsoft, and others.
Data Aggregators 214 are tools or systems that aggregate data from various sources for further processing. Examples of Data Aggregators 214 include Data Warehouse Solutions.
Data Sources 215 include various external data sources used to gather additional required information. Examples of Data Source 215 include Orbis, Comply Advantage, S&P Panjiva, Google searches, websites, and AI Assistants.

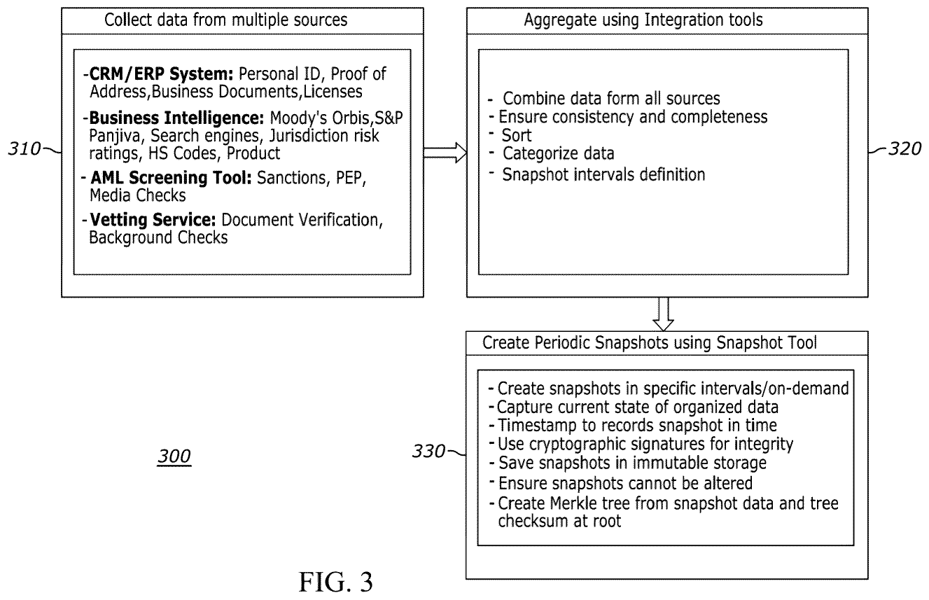

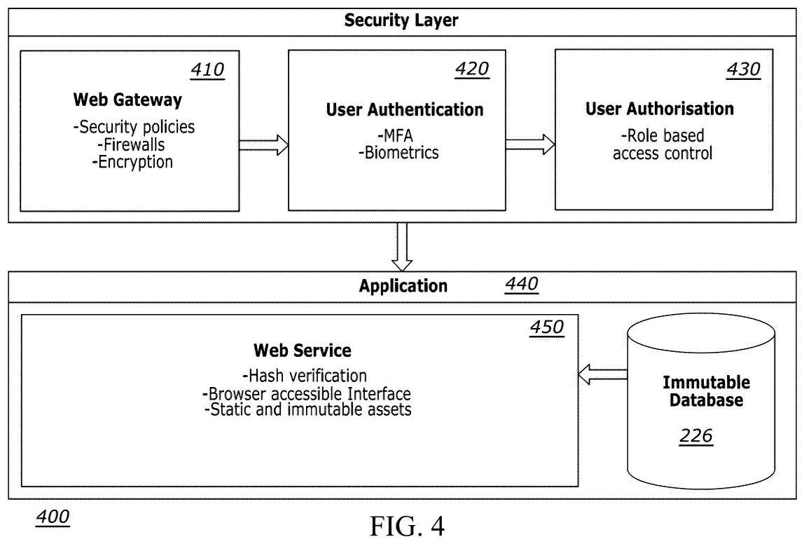

This section represents the components involved in processing and storing the aggregated KYT data in an immutable manner within the embedding system 120. To begin, a secure communication connection is established between vetting systems 110 and embedding systems 120. The embedding system 120 includes
Auth (Authentication) module 221 that handles authentication to ensure secure access through the global telecommunications network, such as the internet 240. This is further described with reference to FIG. 4 below.
Application 222 is the main application that interacts with other components for data processing and access.
Snapshot retrieval 224 is the module responsible for retrieving snapshots from the immutable database.
Immutable Database 226 stores signed and timestamped snapshots immutably. Examples of immutable database systems include those available from Immudb, Dolt, Amazon Quantum Ledger Database, and others.
Snapshot creation 228 handles the creation of periodic snapshots of aggregated data and embeds them into payment message-based systems. This is further described in FIG. 3 below.

### Data Collection and Snapshot Creation Process

FIG. 3 depicts an overall flow 300 of the data collection and snapshot creation process, according to one example of the present invention. The process begins with collecting data from multiple sources in step 310 as previously described above in FIG. 1. The data is gathered from KYT data from CRM/ERP, an AML screening tool, and vetting service. Data includes personal identification (driver's license, passports, government-issued IDs), proof of address, business documents (articles of incorporation, business certificates, licenses. Business intelligence, such as that available from Moody's, Orbis, S&P, Panjiva, search engine results, jurisdictional ratings, HS (Harmonized System) codes, and details about products or services. The process continues to step 320.

In step 320, the data from step 310 is aggregated, sorted, organized, and may be sanitized and converted into a standardized format. The process continues to step 330.

In step 330, the snapshot is created by packaging aggregated data of from step 320. In one example, the snapshot is taken periodically. This provides the most up-to-date information to the parties. Typically, interim snapshots are considered drafts, and a link to the final vetted snapshot is embedded in the telecommunication message. The snapshots are timestamped and cryptographically hashed, signed, and stored in an immutable database 226. The signature in one example is that of the embedding system 120. A Merkel tree or hash tree for the snapshot is created to verify all previous related snapshots. A hash reference number may be created for each snapshot. The hash references are used subsequently for secure access and verification.

### Secure Access Process

FIG. 4 depicts an overall flow 400 of sharing, embedding, and accessing process using the global telecommunications network 240 of FIG. 2 described above.

A request is received by a web gateway 410 that provides network security mechanisms, including IP range access, throttling, routing, redirects, and secure transmission protocols. Examples of providers of web gateways 410 include Cisco, Barracuda, Symantec, and others. The process proceeds to step 420.

In step 420, user authentication is performed using multifactor authentication (MFA) and or biometric verification. Once authenticated, the process proceeds to authentication controls 430 using role-based access control (RBAC) and to web services 440.

Application 440 encrypts data at rest and in transit to protect sensitive information. Cryptographic hash references, such as Merkle root, to verify the integrity of the data before access. Immutable assets are retrieved from the immutable database 226.

### Sharing Compliance Data Flow

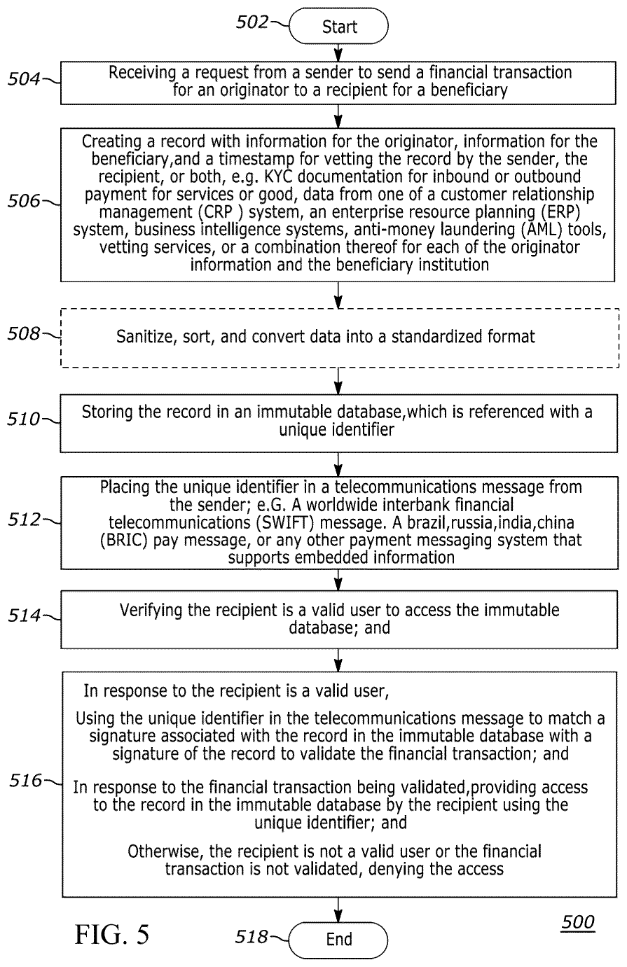

FIG. 5 depicts an overall flow 500 for the sharing of compliance data. The process begins in step 502 and immediately proceeds to step 504.

In step 504, a request is received from a sender to initiate a financial transaction for an originator to a recipient on behalf of a beneficiary. An example would be an international wire transfer between company A (originator) to pay for inbound goods from company B (beneficiary). The process flows to step 506.

In step 506, a record containing information for the originator, the beneficiary, and a timestamp for vetting by the sender, the recipient, or both is created. In one example the information includes one of an originator's business license, an originator's business registration, originator's ultimate beneficial owner, or a combination thereof. For a good, the information may include an originator's date of invoice, currency, an amount in numerical format, an amount in written format, originator's company logo, originator's unique invoice number, a beneficiary's name and address, product description, bank details, original seal, originator's name and address, a commercial invoice or a combination thereof.

The information may be data from one of a customer relationship management (CRM) system, an Enterprise Resource Planning (ERP) system, business intelligence systems, Anti-Money Laundering (AML) tools, vetting services, or a combination thereof for each of the originator information and the beneficiary institution. The process continues to the optional step 508.

In optional step 508, the data retrieved to create the record may be sanitized to remove unnecessary data, sorted, and converted to a standardized format. The process continues to step 510.

In step 510, the record is stored in an immutable database, which is referenced with a unique identifier. The process continues to step 512.

In step 512, the unique identifier is placed in a telecommunications message from the sender. Examples of telecommunication messages includes a Worldwide Interbank Financial Telecommunications (SWIFT) message, a Brazil, Russia, India, China (BRIC) Pay message, local or regional RTGS messages such as ACH (US) CHAPS (UK) or Fast Payment System messaging such as (RTP, FedNow (US) FPS (UK) or any other payment messaging system that supports embedded information. The process continues to step 514.

In step 514, the recipient is verified as a valid user to access the immutable database. The process continues to step 516.

In step 516, in response to the recipient being a valid user, the unique identifier is used in the telecommunications message to match a signature associated with the record in the immutable database with a signature of the record to validate the financial transaction. in response to the financial transaction being validated, providing the recipient access to the record in the immutable database using the unique identifier; otherwise, denying access if the recipient is not a valid user or the financial transaction is not validated. The process continues to step 518.

The process ends in step 518.

### Compliance Data Vetting Report

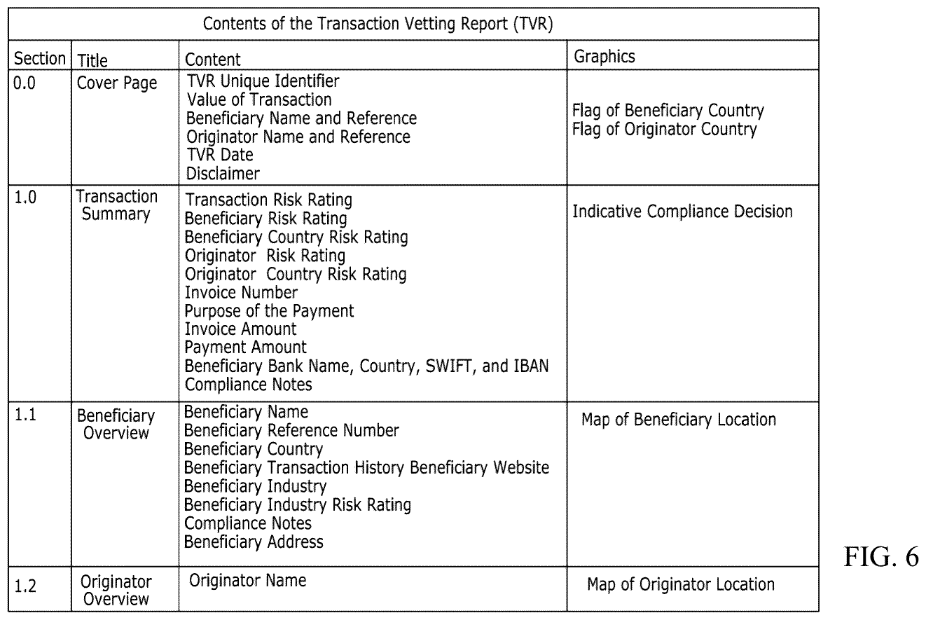

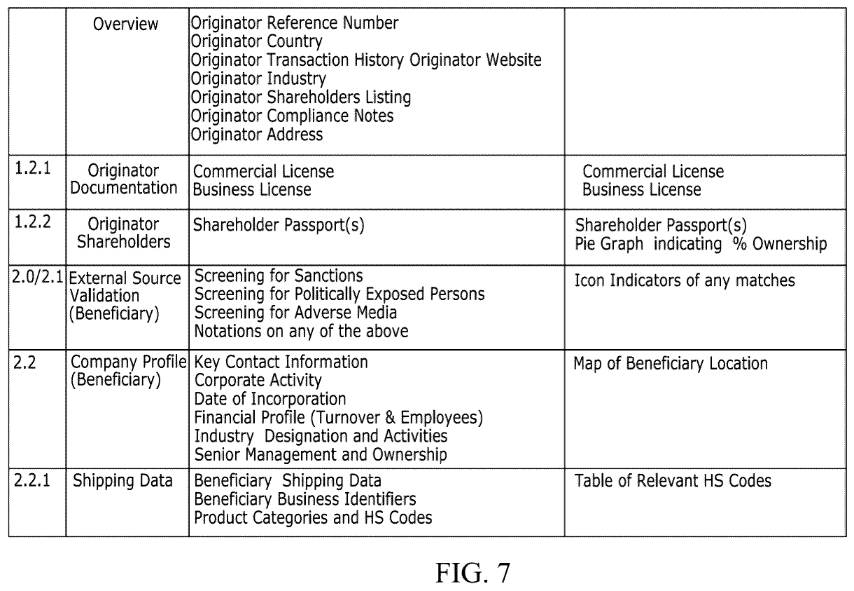

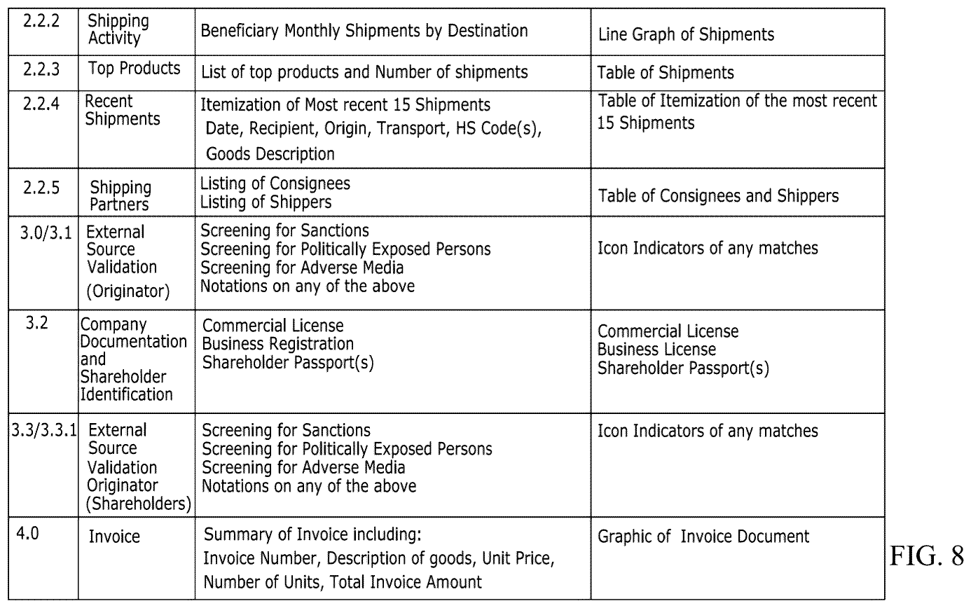

FIG. 6 through FIG. 8 is an example of a compliance data vetting report, according to one aspect of the present invention in a standardized format

### Generalized Computer/Server System

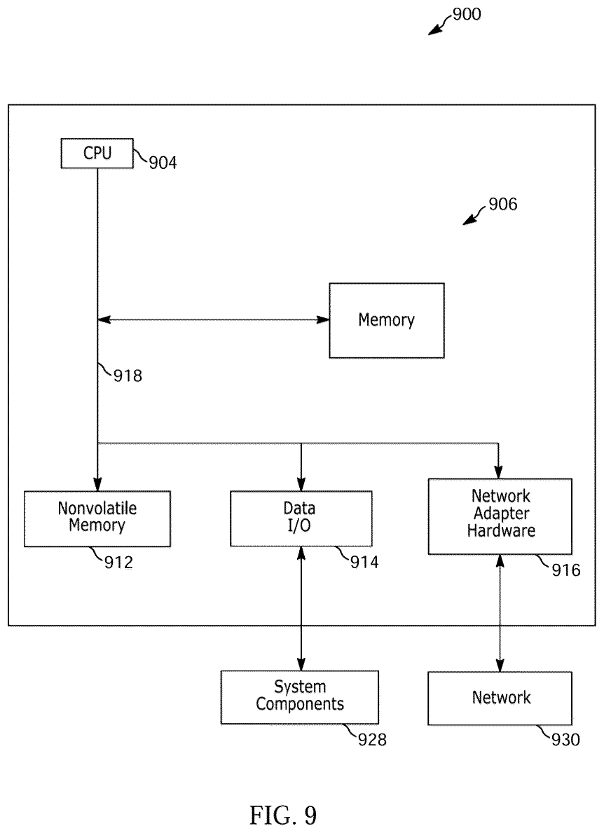

FIG. 9 depicts a block diagram illustrating a processing system 900. The processing system 900 is an example of a processing subsystem that can perform any of the above-described processing operations, control operations, other operations, or combinations of these.

The processing system 900 in this example includes a CPU 904 that is communicatively connected to a main memory 906 (e.g., volatile memory), and a non-volatile memory 912 to support processing operations. The CPU 904 is further communicatively coupled to a network adapter hardware 916 to support input and output communications with external computing systems, such as through the illustrated network 930.

The processing system 900 further includes a data input/output (I/O) processor 914 that can be adapted to communicate with any type of equipment, such as the illustrated system components 928. The data input/output (I/O) processor, in various examples, can be configured to support any type of data communications connection, including present-day analog and/or digital techniques or via a future communications mechanism. A system bus 918 interconnects these system components.

### Information Processing System

The present subject matter can be realized in hardware, software, or a combination of hardware and software. A system can be realized in a centralized fashion in one computer system or in a distributed fashion where different elements are spread across several interconnected computer systems. Any kind of computer system—or other apparatus adapted for carrying out the methods described herein—is suitable. A typical combination of hardware and software could be a general-purpose computer system with a computer program that, when loaded and executed, controls the computer system to carry out the methods described herein.

The present subject matter can also be embedded in a computer program product, which comprises all the features enabling the implementation of the methods described herein, and which—when loaded in a computer system—is able to carry out these methods. Computer program in the present context means any expression, in any language, code, or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers, and at least one computer-readable medium that allows a computer to read data, instructions, messages, message packets, and other computer-readable information from the medium. The computer-readable medium may include a computer-readable storage medium embodying non-volatile memory, such as read-only memory (ROM), flash memory, disk drive memory, CD-ROM, and other permanent storage. Additionally, a computer medium may include volatile storage such as RAM, buffers, and cache memory, as well as network circuits. Furthermore, the computer-readable medium may comprise computer-readable information in a transitory state medium such as a network link and/or a network interface, including a wired network or a wireless network, that allows a computer to read such computer-readable information. In general, the computer-readable medium embodies a computer program product as a computer-readable storage medium that embodies computer-readable program code with instructions to control a machine to perform the above-described methods and realize the above-described systems.

### Non-Limiting Examples

Although specific embodiments of the subject matter have been disclosed, those having ordinary skill in the art will understand that changes can be made to the specific embodiments without departing from the spirit and scope of the disclosed subject matter. The scope of the disclosure is not to be restricted, therefore, to the specific embodiments, and it is intended that the appended claims cover any and all such applications, modifications, and embodiments within the scope of the present disclosure.

Although specific embodiments of the invention have been discussed, those having ordinary skill in the art will understand that changes can be made to the specific embodiments without departing from the scope of the invention. The scope of the invention is not to be restricted, therefore, to the specific embodiments, and it is intended that the appended claims cover any and all such applications, modifications, and embodiments within the scope of the present invention.

It should be noted that some features of the present invention may be used in one embodiment thereof without the use of other features of the present invention. As such, the foregoing description should be considered as merely illustrative of the principles, teachings, examples, and exemplary embodiments of the present invention and not a limitation thereof.

Also, these embodiments are only examples of the many advantageous uses of the innovative teachings herein. In general, statements made in the specification of the present application do not necessarily limit any of the various claimed inventions. Moreover, some statements may apply to some inventive features but not to others.

The description of the present invention has been presented for purposes of illustration and description and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention and its practical application and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method to share compliance data in an electronic financial transaction, the method on a server comprising:
receiving a request from a sender to send a financial transaction for an originator to a recipient for a beneficiary;
creating a record with information for the originator, information for the beneficiary, and a timestamp for vetting the record by the sender, the recipient, or both;
storing the record in an immutable database, which is referenced with a unique identifier;
placing the unique identifier in a telecommunications message from the sender;
verifying the recipient is a valid user to access the immutable database; and
in response to the recipient is a valid user,
using the unique identifier in the telecommunications message to match a signature associated with the record in the immutable database with one of a signature, checksum, a hash of the record, or a combination thereof, to validate the financial transaction;
in response to the financial transaction being validated, providing access to the record in the immutable database by the recipient using the unique identifier; and
otherwise, the recipient is not a valid user or the financial transaction is not validated, denying the access.

2. The method of claim 1, wherein the matching the signature associated with the record in the immutable database with the signature of the sender to validate the financial transaction, includes comparing a hash associated with the record in the immutable database with a hash of generated by the recipient to validate the financial transaction.

3. The method of claim 1, wherein the receiving the telecommunications message includes receiving one of a Worldwide Interbank Financial Telecommunications (SWIFT) message, a Brazil, Russia, India, China (BRIC) Pay message, local or regional RTGS messages such as ACH (US) CHAPS (UK) or Fast Payment System messaging such as RTP, FedNow, FPS, or any other payment messaging system that supports embedded information.

4. The method of claim 3, wherein the sender has a sender SWIFT code, and the recipient has a recipient SWIFT code.

5. The method of claim 4, wherein the placing the unique identifier in the telecommunications message includes placing the unique identifier in one of a SWIFT MT field, a SWIFT MX field, or both of the sender SWIFT code.

6. The method of claim 1, wherein the creating the record with information for the originator, information for the beneficiary, and the timestamp includes one of an originator's business license, an originator's business registration, an originator's ultimate beneficial owner, or a combination thereof.

7. The method of claim 6, wherein the creating the record with information for the originator, information for the beneficiary, and the timestamp includes one of an originator's date of invoice, currency, an amount in numerical format, an amount in written format, originator's company logo, originator's unique invoice number, a beneficiary's name and address, product description, bank details, original seal, originator's name and address or a combination thereof.

8. The method of claim 6, wherein the creating the record with information for the originator, information for the beneficiary, and the timestamp includes one of an originator's commercial invoices.

9. The method of claim 1, wherein the creating the record with information for the originator, information for the beneficiary, and the timestamp further includes creating the record with data from one of a customer relationship management (CRM) system, an Enterprise Resource Planning (ERP) system, business intelligence systems, Anti-Money Laundering (AML) tools, vetting services, transaction monitoring, rules based verification systems or a combination thereof for each of the originator and the beneficiary.

10. The method of claim 1, in which the data is converted into a standardized format prior to creating the record.

11. The method of claim 10, in which the data is categorized and sorted prior to being converted into the standardized format.

12. The method of claim 1, further comprising:
an intermediary that receives the telecommunication message from the sender to send the financial transaction to the recipient.

13. An apparatus to share compliance data in an electronic financial transaction, comprising:
one or more processors; and
one or more non-transitory computer-readable storage media storing instructions that, when executed by the one or more processors, cause the apparatus to:
receive a request from a sender to send a financial transaction for an originator to a recipient for a beneficiary;
create a record with information for the originator, information for the beneficiary, and a timestamp for vetting the record by the sender, the recipient, or both;
store the record in an immutable database, which is referenced with a unique identifier;
place the unique identifier in a telecommunications message from the sender;
verifying the recipient is a valid user to access the immutable database; and
in response to the recipient is a valid user,
use the unique identifier in the telecommunications message to match a signature associated with the record in the immutable database with one of a signature, checksum, a hash of the record, or a combination thereof, to validate the financial transaction;
in response to the financial transaction being validated, provide access to the record in the immutable database by the recipient using the unique identifier; and
otherwise, the recipient is not a valid user or the financial transaction is not validated, denying the access.

14. The apparatus of claim 13, wherein the matching the signature associated with the record in the immutable database with the signature of the sender to validate the financial transaction, includes comparing a hash associated with the record in the immutable database with a hash of generated by the recipient to validate the financial transaction.

15. The apparatus of claim 13, wherein the receiving the telecommunications message includes receiving one of a Worldwide Interbank Financial Telecommunications (SWIFT) message, a Brazil, Russia, India, China (BRIC) Pay message, local or regional RTGS messages such as ACH (US) CHAPS (UK) or Fast Payment System messaging such as RTP, FedNow, FPS, or any other payment messaging system that supports embedded information.

16. The apparatus of claim 15, wherein the sender has a sender SWIFT code, and the recipient has a recipient SWIFT code.

17. The apparatus of claim 16, wherein the placing the unique identifier in the telecommunications message includes placing the unique identifier in one of a SWIFT MT field, a SWIFT MX field, or both of the sender SWIFT code.

18. The apparatus of claim 13, wherein the creating the record with information for the originator, information for the beneficiary, and the timestamp includes one of an originator's business license, an originator's business registration, an originator's ultimate beneficial owner, or a combination thereof.

19. The apparatus of claim 18, wherein the creating the record with information for the originator, information for the beneficiary, and the timestamp includes one of an originator's date of invoice, currency, an amount in numerical format, an amount in written format, originator's company logo, originator's unique invoice number, a beneficiary's name and address, product description, bank details, original seal, originator's name and address or a combination thereof.

20. The apparatus of claim 18, wherein the creating the record with information for the originator, information for the beneficiary, and the timestamp includes one of an originator's commercial invoices.
